(19) United States
(12) Patent Application Publication
(10) Pub. No.: US 2008/0286039 A1
(43) Pub. Date: Nov. 20, 2008

(54) STRESS REDUCTION FOR PULVERIZER MAIN SHAFT VIA FLEXIBLE STRUCTURE

(76) Inventors: William N. Martin, Brecksville, OH (US); Ronald D. Mizak, Wadsworth, OH (US); Andrew E. Jackson, City of Green, OH (US)

Correspondence Address: THE BABCOCK & WILCOX COMPANY, PATENT DEPARTMENT, 20 SOUTH VAN BUREN AVENUE, BARBERTON, OH, 44203, US

(21) Appl. No.: 11/748,662

(22) Filed: May 15, 2007

(51) Int. Cl. F16C 19/50

(52) U.S. Cl. 403/365; 384/280

(57) ABSTRACT

A yoke bushing that reduces the cyclic movement between the main shaft of a ball-and-race type coal pulverizer, thereby resulting in longer shaft life and reduced incidences of shaft failure. The yoke bushing is comprised of a flexible structure that provides individual contact areas which will have, at the same locations, equal stress fields between the main shaft and the yoke bushing.

### FIELD AND BACKGROUND OF THE INVENTION

The present invention relates, in general, to the field of coal pulverizers, and more particularly, to stress reduction modifications that will provide longer shaft life and reduced incidences of shaft failure in ball-and-race type coal pulverizers.

Coal pulverizers are used to grind, dry and classify raw chunks of coal into fine solids which can be fluidized and fed, for example, to burners used in conjunction with utility and/or industrial boilers or furnaces. As is known to those skilled in the art, several different types of coal pulverizers or coal mills exist today, including one known as the EL pulverizer that was first produced by The Babcock & Wilcox Company in the early 1950's, and is a ball-and-race type pulverizer which employs the ball thrust bearing principle to grind the coal.

In prior art FIGS. 1 and 1A there is shown an EL pulverizer 10 which includes an upper housing section 32 and a lower housing section 34. The lower housing section 34 encloses a gear box 35 mounted on a foundation 37. The upper housing section 32 encloses the pulverizing zone 36 which includes two vertical axis horizontal grinding rings 12 or 12′ and 14, and a set of balls 16 placed between the grinding rings. The lower or bottom grinding ring 12 may be provided as a two-piece ring 12, which rests in and is secured (via a key or the like) to a ring seat 44. The ring seat 44 deflects hot incoming primary air from directly impacting the lower grinding ring 12. As is known to those skilled in the art, the hot, incoming primary air is used to dry the coal being ground in the pulverizer 10 and to transport the ground coal particles out of the pulverizer 10. Alternatively, the lower or bottom grinding ring may be provided as a thicker, one-piece lower or bottom grinding ring 12′ (See FIG. 1A), rests upon and is secured to the pulverizer yoke 18. The pulverizer yoke 18 rotates through connection to a rotating, vertical main shaft 20, while the upper or top grinding 14 remains stationary and is spring loaded to provide the pressure for grinding the coal. The pressure required for efficient grinding is obtained from externally adjustable dual purpose springs 22 which are referred to as such, because in addition to providing the loading forces required to efficiently grind the coal, the dual purpose springs 22 also supply the forces required to keep the upper grinding ring 14 from experiencing excessive radial movement, circumferential twisting, and eccentric rotation with respect to the bottom grinding ring 12 or 12′. The coal is ground by contact with the upper and lower grinding rings 14 and 12 or 12′, and the balls 16. The upper and lower grinding rings 14 and 12 or 12′ are each provided with a race having a predefined, matching track contour that engages the balls 16. The force from the upper grinding ring 14 pushes the balls 16 against the coal layer on the lower grinding ring 12 or 12′. Ground coal is swept from the grinding zone, defined by the grinding rings 12 or 12′ and 14 and the balls 16, by air for final particle size classification and subsequent pneumatic transport to one or more coal burners. Oversized coal particles are returned to the pulverizing zone 36. The pulverizer 10 is provided with a gear drive assembly 24 which includes bevel gears 26 and 28 positioned on a horizontal pinion shaft 30 and at the base of the vertical main shaft 20, respectively.

Typically, the grinding balls 16 operate within a predetermined range of acceptable resistance force exerted on the grinding balls by the coal engaged between the upper and lower grinding rings 14 and 12 or 12′ and the grinding balls 16. If the acceptable resistance force is exceeded due to, for example, an encounter with coal particles of relatively high hardness and of greater than acceptable size, this may result in impact and shock loads. It can also be appreciated that foreign matter such as tramp iron may be engaged between the upper and lower grinding rings and the grinding balls, and this occurrence may cause the grinding balls to partially leave their original track and result in eccentric loads. The main shaft has a closely fitted mechanical joint with the lower grinding ring and, in addition to driving forces; this joint is subjected, at some frequency, to impact, shock, and eccentric loads from the coal grinding operation which all contribute to severe stresses on the shaft.

Currently, there is some concern as to main shaft failure. It is believed that the shaft failures are initiated by the deterioration of the finely machined outside surface of the tapered portion of the main shaft 20 and the bore surface of the yoke bushing 21. The deterioration is caused by cyclic movement between the contacting surfaces of the main shaft 20 and the yoke bushing 21. This movement is a consequence of the cyclic or alternating type bending loads experienced at the top end of the main shaft. Because the loads are cyclic, there occurs a progressive form of damage known as fretting. Fretting damage, sometimes referred to as fretting corrosion, is a condition of surface deterioration brought on by very small relative movements between bodies in contact. The surface deterioration caused by fretting creates a stress multiplier on the surface of the shaft, which raises the intensity of the combined torsional and bending stress to the ultimate stress of the shaft. This combined stress will initiate a crack in the shaft. Since the crack is also a stress multiplier, the shaft continues to crack from otherwise tolerable combined stresses. Also of concern is fatigue failure when stress concentration, cyclic loading and fretting corrosion are combined. Like fretting, fatigue has a definite set of characteristics which combine to identify this failure phenomenon. Pulverizer vibration usually results in high shaft stress levels, and may have a role in main shaft failures. Vibration may be caused by abnormal grinding element wear such as out-of-round wear of balls or rings and, also by failure to maintain a proper air/coal ratio to the pulverizers.

There have been many attempts at correcting main shaft failure frequency such as applying a dry lubricant or a ceramic coating between the yoke end of the main shaft and the yoke bushing bore area, providing the yoke bushing with circumferential grooves, providing the main shaft with a reduced diameter portion below the yoke bushing, employing an anti-seize compound at the main shaft-to-yoke bushing joint, using a full contact yoke bushing or one with an undercut center portion, shot peening, and nitriding as a surface hardening process. Remedial efforts notwithstanding, even carefully fitted taper joints, when subjected to cyclic bending forces often exhibit vulnerability to fatigue failure of main shafts because of fretting and stress produced at the joint between the main shaft and the yoke bushing.

There continues to be a need for an improved joint between the main shaft and the yoke bushing for these types of pulverizers, one that will reduce fretting and bending fatigue and thus provide an improved shaft life which will result in more reliable ball-and-race coal pulverizer performance.

### SUMMARY OF THE INVENTION

The present invention is directed at a yoke bushing structure that reduces the cyclic movement between the main shaft and the yoke bushing, and comprises a flexible joint that provides individual contact areas which will have, at the same locations, equal stress fields between the main shaft and the yoke bushing.

In accordance with the invention, the yoke bushing is comprised of spaced upper and lower portions connected by a flexile band whose thickness is less than that of either the upper or the lower portions of the bushing. The location of the flexile band can be either bordering the pulverizer yoke, medially nested between the vertical main shaft and the pulverizer yoke, or bordering the vertical main shaft. The flexile band can be perforated so as to enhance its flexibility.

In another embodiment of the invention, a flexile elastomeric material is provided in the space between the main shaft and the flexile band bordering the yoke.

In still another embodiment of the invention, the yoke bushing is comprised of spaced upper and lower portions with a flexile elastomeric sleeve interposed there between and around the vertical main shaft.

In a further embodiment of the invention, the yoke bushing is comprised of spaced upper and lower portions with a flexile plurality of vertically stacked and detached annular disks interposed there between.

In a further embodiment of the invention, the yoke bushing is comprised of spaced upper and lower portions connected by circularly-spaced flexile vertical rods which are preferably equidistant from one another.

In a still further embodiment of the invention, the yoke bushing is comprised of spaced upper and lower portions with a flexile plurality of detached contiguous bushing portions interposed there between.

In still another embodiment of the invention, the yoke bushing is comprised of upper and lower portions which are spaced from one another by a relatively narrow air gap.

These and other features and advantages of the present invention will be better understood and its advantages will be more readily appreciated from the detailed description of the preferred embodiment, especially when read with reference to the accompanying drawings.

### BRIEF DESCRIPTION OF THE DRAWINGS

FIG. 1 is a sectional side view of a prior art type EL ball and race pulverizer, wherein the lower or bottom grinding ring rests in and is secured to a ring seat which rests upon and is secured to the pulverizer yoke;

FIG. 1A is a sectional side view of a prior art type EL ball and race pulverizer where the bottom ring is a thicker, one-piece ring;

FIG. 2 is a sectional side view of a flexible tubular bushing, according to the present invention, wherein the flexile means includes a band bordering the yoke;

FIG. 3 is a sectional side view of a flexible tubular bushing, according to the present invention, wherein the flexile means includes a band medially nested between the main shaft and the yoke;

FIG. 4 is a sectional side view of a flexible tubular bushing, according to the present invention, wherein the flexile means includes a band bordering the main shaft;

FIG. 5 is the flexible tubular bushing of FIG. 2, wherein the band is perforated;

FIG. 6 is the flexible tubular bushing of FIG. 3, wherein the band is perforated;

FIG. 7 is the flexible tubular bushing of FIG. 4, wherein the band is perforated;

FIG. 8 is the flexible tubular bushing of FIG. 2, including an elastomeric material fitted between the band and the main shaft;

FIG. 9 is the flexible tubular bushing of FIG. 8, wherein the band is perforated;

FIG. 10 is a sectional side view of a flexible tubular bushing, according to the present invention, wherein the flexile means includes an elastomeric sleeve;

FIG. 11 is a sectional side view of a flexible tubular bushing, according to the present invention, wherein the flexile means includes a plurality of vertically stacked and detached annular disks;

FIG. 12 is a sectional side view of a flexible tubular bushing, according to the present invention, wherein the flexile means includes circularly-spaced rods extending between the upper and lower portions of the bushing;

FIG. 13 is a sectional side view of a flexible tubular bushing, according to the present invention, wherein the flexile means includes a plurality of contiguous bushing portions; and

FIG. 14 is a sectional side view of a flexible tubular bushing, according to the present invention, wherein the flexile means includes spaced upper and lower bushing portions.

### DESCRIPTION OF THE PREFERRED EMBODIMENT

Reference will hereinafter be made to the accompanying drawings wherein like numerals designate the same or functionally similar elements throughout the various figures. In the setting of the present invention, the axial loads which have to be dealt with are those axial loads which are aligned substantially parallel to the vertical axis of the pulverizer main shaft.

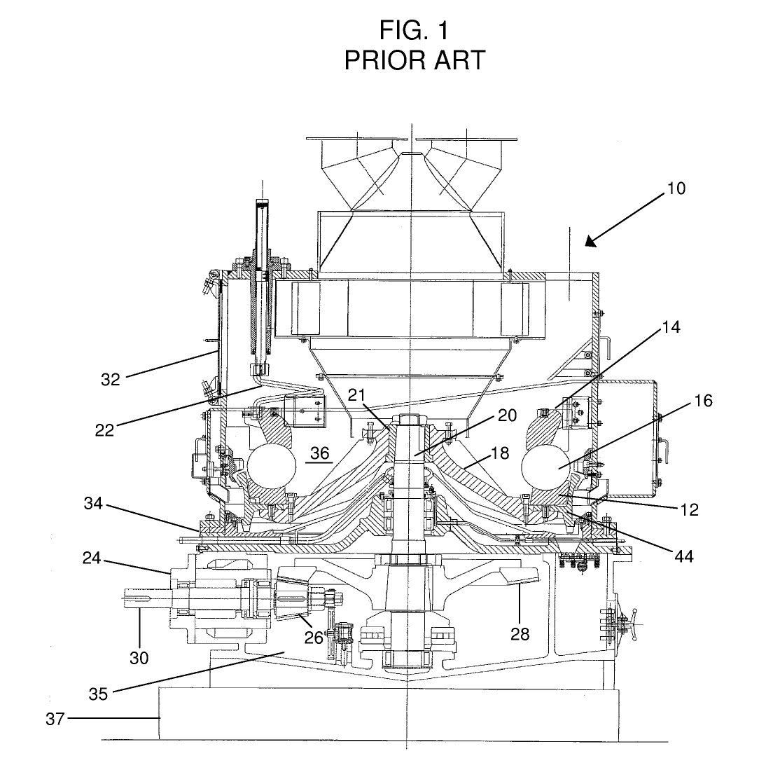

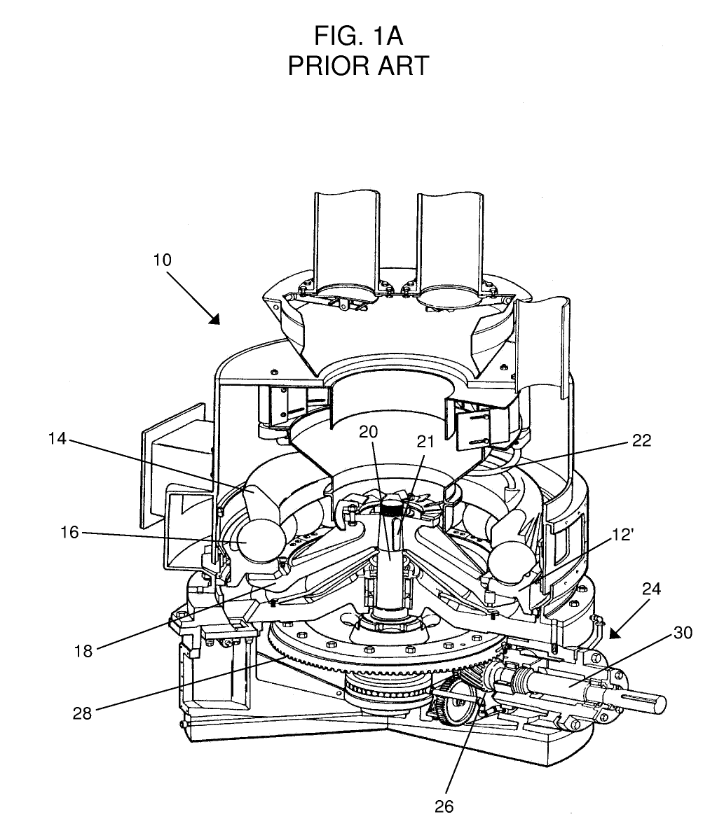

The present invention resides in a flexible yoke bushing in ball-and-race pulverizers to provide longer main shaft life and reduced incidences of shaft failure. FIG. 1 of the present disclosure illustrates ball-and-race pulverizers 10 which employ a lower or bottom grinding ring 12 which rests in and is secured (via a key or the like) to a ring seat 44, and wherein the ring 44 rests upon and is secured to the pulverizer yoke 18. However, the concepts of the present invention are not limited to pulverizers 10 provided with such types of lower or bottom grinding rings 12. The concepts of the present invention also apply to ball-and-race pulverizers 10 which employ a one piece lower or bottom grinding ring 12′, which rests upon and is secured to the pulverizer yoke, such as illustrated in FIG. 1A, for example.

Referring to FIGS. 1 and 1A, there is shown a pulverizer yoke 18 which rotates through connection to a rotating, vertical main shaft 20. A tapered top end portion of shaft 20 lies within the bore of yoke 18 and is surrounded by a yoke bushing 21. The pulverizer operation generates cyclic or alternate type bending loads in the top end of the main shaft 20, and causes deterioration of the finely machined surfaces within the joint of the tapered portion of shaft 20 and the bore of yoke bushing 21. The deterioration is the result of cyclic movement between the mating surfaces of the shaft 20 and the bore of yoke bushing 21. This movement is caused by the bending of the shaft 20 which produces differing stress fields in the yoke bushing 21 and the shaft 20, and gives rise to a progressive form of damage known as fretting.

An approach for preventing the damage due to fretting is to reduce the cyclic movement between the main shaft 20 and the yoke bushing 21. This reduced movement will, in turn, equalize the stress fields between the top and bottom contact surfaces between the shaft 20 and the yoke bushing 21. The flexible yoke bushing 21 interposed between the main shaft 20 and the yoke 18 reduces cyclic movement and provides individual contact areas that will have, at the same axial location, equal stress fields between the main shaft 20 and the yoke bushing 21.

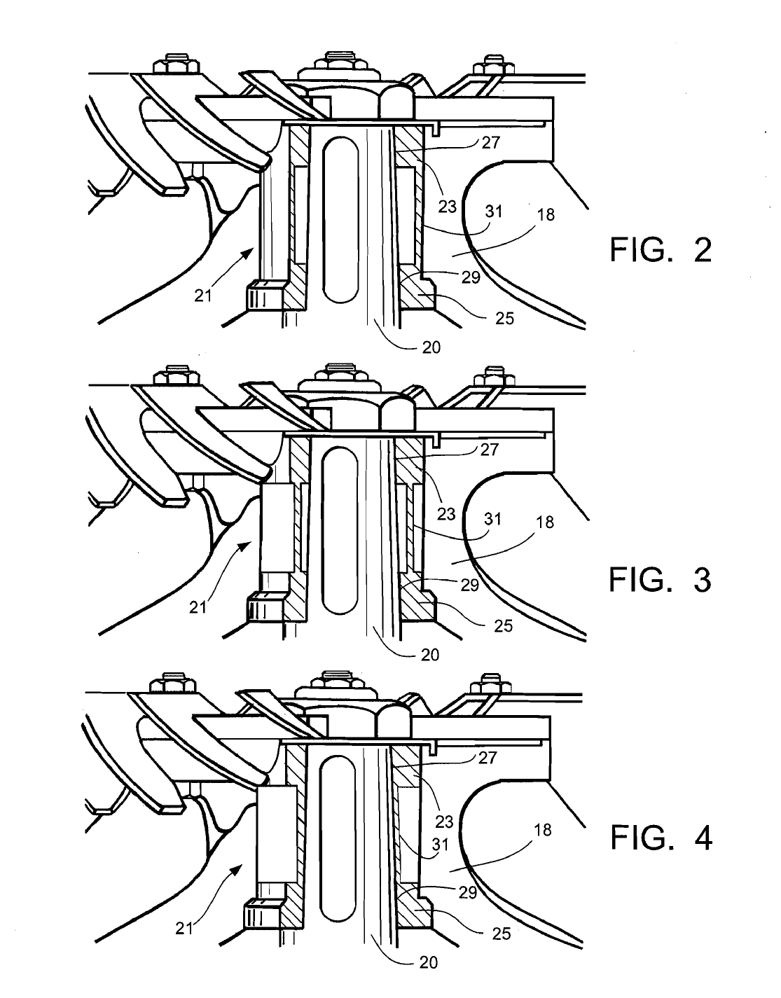

Referring to FIGS. 2, 3, and 4, there is shown a flexible bushing 21 interposed between the main shaft 20 and the yoke 18. The flexible bushing 21 is comprised of an upper portion 23 and a lower portion 25 which are spaced from one another, and has an upper area 27 and a lower area 29 contacting the shaft 20. The upper and lower portions 23 and 25 of the flexible bushing 21 are connected by a flexile means such as a thin cylindrical or frusto-conical flexible band of metal 31 which allows the upper contact area 27 to work independently of the lower contact area 29 because of the flexibility of the metal band 31. As seen in FIG. 2, the flexible band 31 borders upon or is adjacent to the yoke 18; in FIG. 3, the flexible metal band 31 is medially nested between the main shaft 20 and the yoke 18; and in FIG. 4, the flexible metal band 31 borders upon or is adjacent to the main shaft 20.

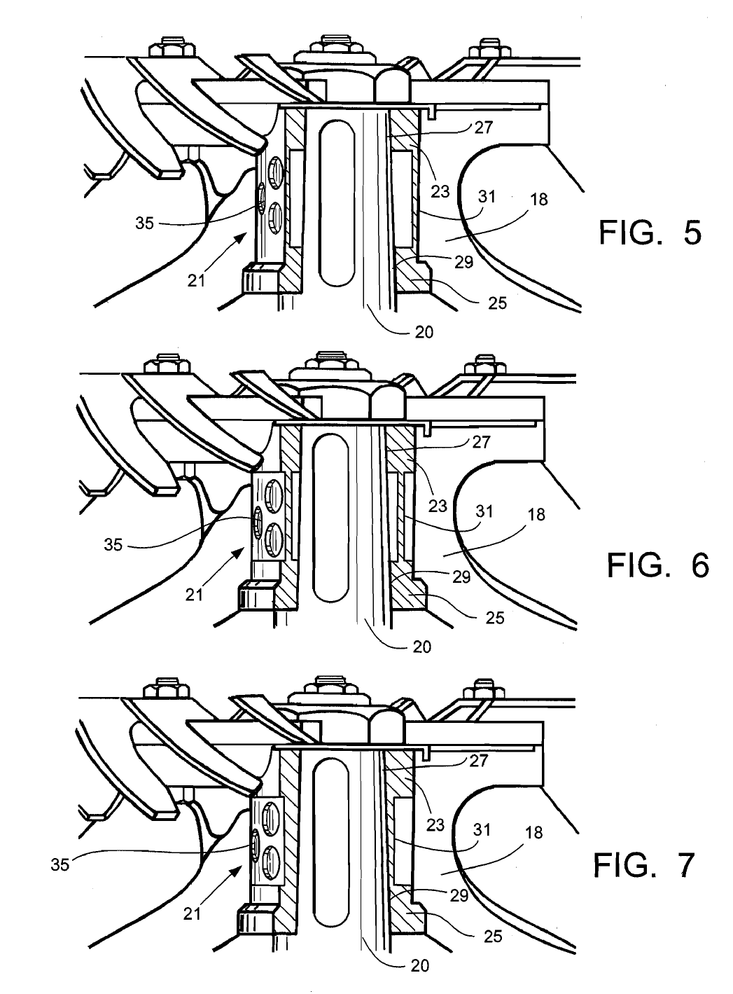

Referring FIGS. 5, 6, and 7, there is shown the flexible bushing 21 of FIGS. 2, 3 and 4 provided with apertures or holes 35 extending through the metal band 31 to enhance its flexibility.

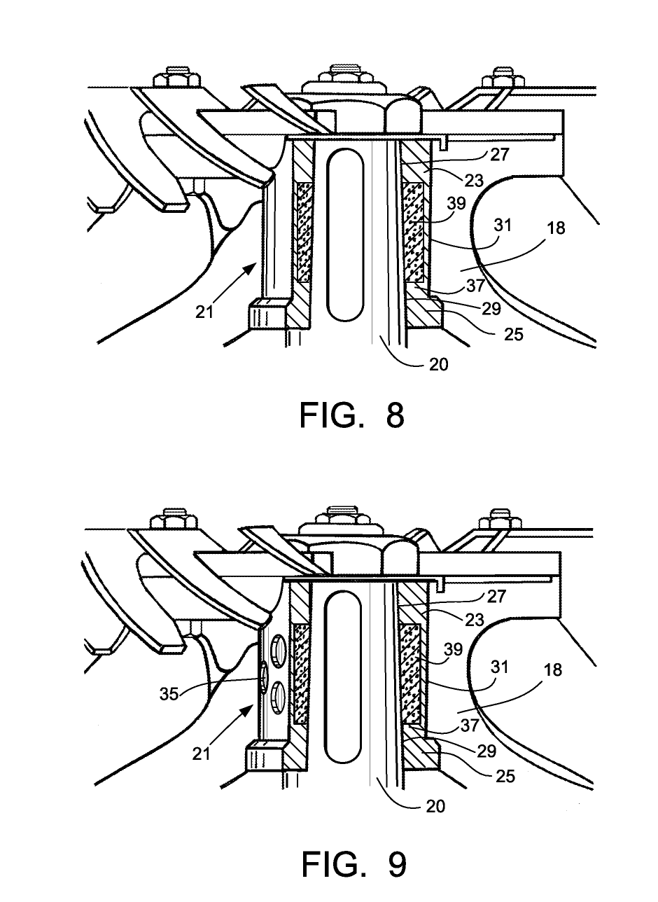

Referring to FIG. 8, there is shown a flexible bushing 21 of FIG. 2 and wherein the enclosed space 37 defined by the upper and lower portions 23 and 25 of the flexible bushing 21, the main shaft 20, and the metal band 31 is occupied by an elastomeric material 39 which promotes the flexibility of the bushing 21 while contributing to its structural integrity.

Referring to FIG. 9, there is shown the flexible bushing of FIG. 8 provided with apertures or holes 35 extending through the metal band 31 to enhance its flexibility.

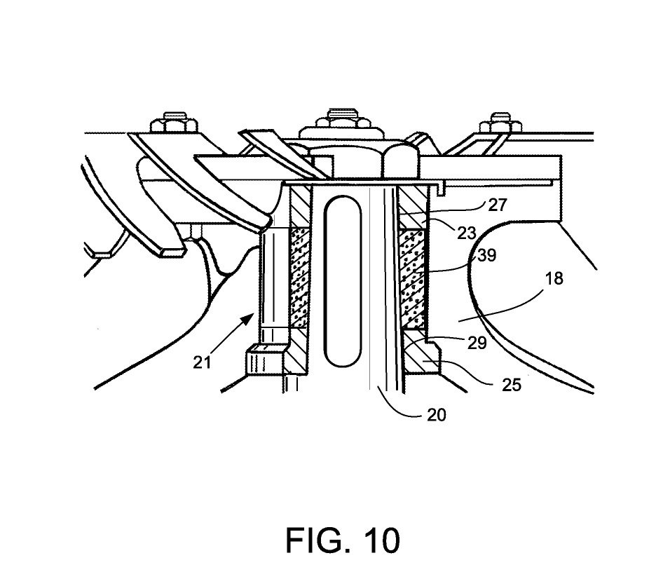

Referring to FIG. 10, there is shown a flexible bushing 21 interposed between the main shaft 20 and the yoke 18. The flexible bushing 21 is comprised of upper and lower portions 23 and 25 which are spaced from one another, and has an upper area 27 and a lower area 29 contacting the shaft 20. An elastomeric material 39 fills the space between the upper and lower portions 23 and 25 of the flexible bushing 21 to promote its flexibility.

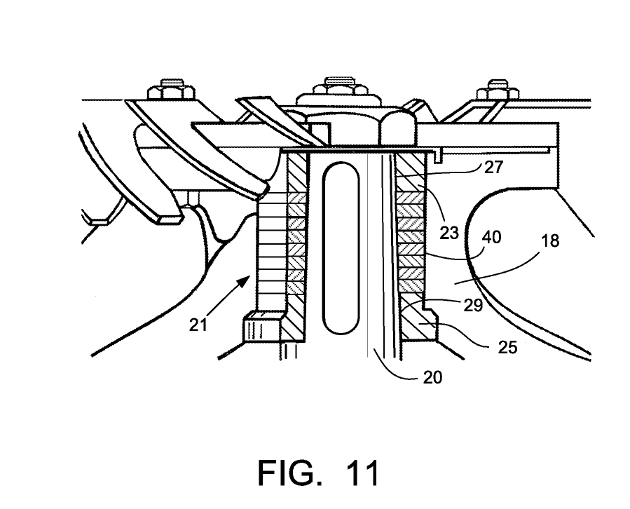

Referring to FIG. 11, there is shown a flexible bushing 21 interposed between the main shaft 20 and the yoke 18. The flexible bushing 21 is comprised of upper and lower portions 23 and 25 which are spaced from one another, and has an upper area 27 and a lower area 29 contacting the shaft 20. A plurality of annular disks or washer like members 40 are interposed between the upper and lower portions 23 and 25 with their inner periphery extending circumferentially around the main shaft 20. The annular disks 40 are detached from one another and from the upper and lower portions 23 and 25 to provide flexibility in bushing 21.

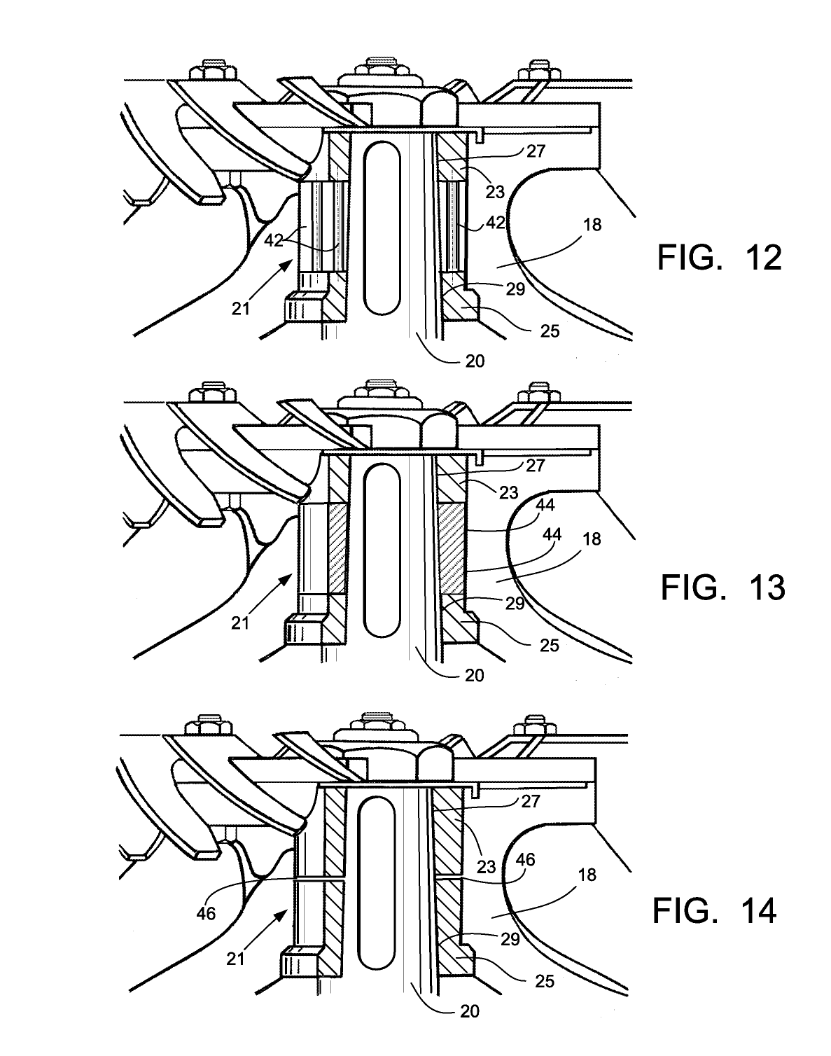

Referring to FIG. 12, there is shown a flexible bushing 21 interposed between the main shaft 20 and the yoke 18. The flexible bushing 21 is comprised of upper and lower portions 23 and 25 interconnected by circularly-spaced pliant rods 42 encircling the main shaft 20. The bushing 21 has an upper area 27 and a lower area 29 contacting the shaft 20.

Referring to FIG. 13, there is shown a flexible bushing 21 interposed between the main shaft 20 and the yoke 18. One or more (a plurality) of contiguously detached bushing portions 44 is/are located between the upper and lower portions 23 and 25 of the flexible bushing 21, which has an upper area 27 and a lower area 29 contacting the shaft 20.

Referring to FIG. 14, there is shown a flexible bushing 21 interposed between the main shaft 20 and the yoke 18. The flexible bushing 21 is comprised of upper and lower portions 23 and 25 which are spaced from one another by a relatively narrow air gap 46, exaggerated in FIG. 14 for clarity. In practice, the upper and lower portions 23 and 25 are in contact with one another. The bushing 21 has an upper area 27 and a lower area 29 contacting the shaft 20.

In accordance with the present invention, during operation of the coal pulverizer 10, each of the contact areas 27 and 29 will develop a stress field. The stress field for each contact area 27 and 29 will have equal stresses in the main shaft 20 and the yoke bushing 21. The equal stresses result in a marked reduction of damage from fretting and a longer operating life for the main shaft 20.

The present invention can be used with either the one-piece, thick bottom grinding ring 12′ or the two-piece bottom grinding ring 12 seated in a ring seat 44.

While specific embodiments of the invention have been shown and described in detail to illustrate the application of the principles of the invention, it will be understood that the invention may be embodied otherwise without departing from such principles. For example, the present invention may be applied in new construction involving type EL pulverizers, or to the repair, replacement, and modification or retrofitting of existing type EL pulverizers. Thus, while the present invention has been described above with reference to particular means, materials, and embodiments, it is to be understood that this invention may be varied in many ways without departing from the spirit and scope thereof, and therefore is not limited to these disclosed particulars but extends instead to all equivalents within the scope of the following claims.

We claim:

1. An assembly comprising an upright rotatable shaft extending into a rotatable yoke, a flexible tubular bushing interposed between the shaft and the yoke, the bushing including spaced upper and lower portions contacting the shaft.

2. The assembly according to claim 1, including flexile means connecting the upper and lower portions of the bushing.

3. The assembly according to claim 2, wherein the transverse thickness of the flexile means is less than that of the upper and lower portions of the bushing.

4. The assembly according to claim 2, wherein the flexile means includes a band bordering upon the yoke.

5. The assembly according to claim 4, including an elastomeric material located between the flexile means and the shaft.

6. The assembly according to claim 2, wherein the flexile means includes a band medially nested between the shaft and the yoke.

7. The assembly according to claim 2, wherein the flexile means includes a band bordering upon the shaft.

8. The assembly according to claims 4, 6, or 7, wherein the band is formed with perforations.

9. The assembly according to claim 2, wherein the flexile means includes a plurality of circularly-spaced vertical rods extending between the upper and lower portions of the bushing.

10. The assembly according to claim 9, wherein the rods are equally spaced from one another.

11. The assembly according to claim 1, including flexile means interposed between the upper and lower portions of the bushing.

12. The assembly according to claim 11, wherein the flexile means includes an elastomeric sleeve.

13. The assembly according to claim 11, wherein the flexile means includes a plurality of vertically stacked annular disks.

14. The assembly according to claim 11, wherein the flexile means includes a plurality bushing portions.

15. The assembly according to claim 11, wherein the flexibility is achieved by an air gap between the upper and lower portions of the bushings.
